(19) United States
(12) Patent Application Publication
(10) Pub. No.: US 2017/0372821 A1
(43) Pub. Date: Dec. 28, 2017

(54) MAGNETOCALORIC CASCADE AND METHOD FOR FABRICATING A MAGNETOCALORIC CASCADE

(71) Applicant: BASF SE, Ludwighsafen (DE)

(72) Inventors: Florian SCHARF, Frankfurt (DE); Markus SCHWIND, Antwerpen (BE); David VAN ASTEN, Utrecht (NL); Steven Alan JACOBS, Madison, WI (US)

(73) Assignee: BASF SE, Ludwighsafen (DE)

(21) Appl. No.: 15/536,036

(22) PCT Filed: Dec. 7, 2015
(86) PCT No.: PCT/EP2015/078864

§ 371 Date: Jun. 14, 2017

Related U.S. Application Data
(60) Provisional application No. 62/093,527, filed on Dec. 18, 2014.

(51) Int. Cl. H01F 1/01; F25B 21/00

(52) U.S. Cl. CPC H01F 1/012; F25B 21/00; F25B 2321/002

(57) ABSTRACT

A magnetocaloric cascade contains a sequence of magnetocaloric material layers having different Curie temperatures T_{C}, wherein the magnetocaloric material layers include a cold-side outer layer, a hot-side outer layer and at least three inner layers between the cold-side outer layer and the hot-side outer layer.

The present invention is related to a magnetocaloric cascade and to a method for fabricating a magnetocaloric cascade. It is further related to a magnetocaloric regenerator, a heat pump and a heat-pumping method involving the use of a magnetocaloric cascade.

Due to advances in materials research, the magnetocaloric effect (MCE) has emerged as an economically viable alternative to known fluid circulation cooling methods for industry and commercial applications even at room temperature, such as refrigerators, cooling systems for cryoproduction in the process industry, and air conditioning systems. Another field of application of the magnetocaloric effect is in thermomagnetic power generators, i.e., in the conversion of heat to electrical energy.

The magnetocaloric effect occurs under application of an external magnetic field to a suitable magnetocaloric material and under an ambient temperature in the vicinity of its Curie temperature. The applied external magnetic field causes an alignment of the randomly aligned magnetic moments of the magnetocaloric material and thus a magnetic phase transition, which can also be described as an induced increase of the Curie temperature of the material above the ambient temperature. This magnetic phase transition implies a loss in magnetic entropy and in an adiabatic process (thermal isolation from the ambient temperature) leads to an increase in the entropy contribution of the crystal lattice of the magnetocaloric material by phonon generation. As a result of applying the external magnetic field, therefore, a heating of the magnetocaloric material occurs.

In technical cooling applications, this additional heat is removed from the material by heat transfer to an ambient heat sink in the form or a heat transfer medium. Water is an example of a heat transfer medium used for heat removal from the magnetocaloric material.

Subsequently removing the external magnetic field can be described as a decrease of the Curie temperature back below the ambient temperature, and thus allows the magnetic moments reverting back to a random arrangement. This causes an increase of the magnetic entropy and a reduction of the entropy contribution of the crystal lattice of the magnetocaloric material itself, and in adiabatic process conditions thus results in a cooling of the magnetocaloric material below the ambient temperature. The described process cycle including magnetization and demagnetization is typically performed periodically in device applications.

The described cooling effect can be increased by designing the magnetocaloric material as a sequence of layers with decreasing Curie temperatures, or, in other words, as a magnetocaloric cascade containing two or more magnetocaloric material layers in succession by descending Curie temperature. In such a magnetocaloric cascade, the first magnetocaloric material cools down the second magnetocaloric material to a temperature near the Curie temperature of the second magnetocaloric material, and so on with any further magnetocaloric material contained in the cascade. This way, the cooling effect achieved can be greatly increased in comparison with the use of a single magnetocaloric material.

US 2004/0093877 A1 discloses a magnetocaloric material exhibiting a magnetocaloric effect at or near room temperature and a magnetic refrigerator using such magnetocaloric material. Different compositions of the magnetocaloric material yield different magnetocaloric materials exhibiting different Curie temperatures, i.e., different temperatures of the magnetic phase transition. The magnetocaloric materials are arranged in a first and a second regenerator bed which are exposed to varying magnetic fields. The regenerators form the core of a magnetic refrigerator. Similarly, WO 2004/068512 A1 and WO 2003/012801 describe magnetocaloric materials having different Curie temperatures obtained from a material system of a certain composition by varying of individual constituents or the relative amounts of individual constituents.

US2011/0094243 describes heat exchanger beds composed of a cascade of at least three different magnetocaloric materials with different Curie temperatures which are arranged in succession by ascending or descending Curie temperature and are insulated from one another by intermediate thermal and/or electrical insulators, the difference in the Curie temperatures of adjacent magnetocaloric materials being 0.5 to 6 K.

U.S. Pat. No. 8,104,293 B2 discloses a magnetocaloric cooling device comprising a plurality of thermally coupled magnetocaloric elements, one or more reservoirs containing a fluid medium and two heat exchangers. The heat exchangers are thermally coupled to the magnetocaloric elements and to at least one of the reservoirs for transferring heat between the magnetocaloric elements and the environment through the fluid medium.

US 2011/0173993 A1 discloses a magnetocaloric element comprising at least two adjacent sets of magnetocaloric materials arranged according to an increasing Curie temperature. The magnetocaloric materials within a same set have a same Curie temperature. The magnetocaloric element further comprises initiating means for initiating a temperature gradient between two opposite hot and cold ends of the magnetocaloric element.

WO 2014/115057 A1 describes a magnetocaloric cascade containing at least three different magnetocaloric materials with different Curie temperatures, which are arranged in succession by descending Curie temperature, wherein none of the different magnetocaloric materials with different Curie temperatures has a higher layer performance Lp than the magnetocaloric material with the highest Curie temperature. At least one of the different magnetocaloric materials with different Curie temperatures has a lower layer performance Lp than the magnetocaloric material with the highest Curie temperature. The layer performance Lp of a particular magnetocaloric material layer is calculated according to formula: Lp=m*dT_{ad,max} with dT_{ad,max}; maximum adiabatic temperature change which the particular magnetocaloric material undergoes when it is magnetized from a low magnetic field to high magnetic field during magnetocaloric cycling, and m: mass of the particular magnetocaloric material contained in the magnetocaloric cascade.

According to a first aspect of the present invention, a magnetocaloric cascade containing a sequence of at least three magnetocaloric material layers is provided. The magnetocaloric cascade contains a sequence of magnetocaloric material layers having different Curie temperatures T_{C}, wherein
the magnetocaloric material layers include a cold-side outer layer, a hot-side outer layer and at least three inner layers between the cold-side outer layer and the hot-side outer layer,
for each pair of next neighboring magnetocaloric material layers of the magnetocaloric cascade there exists a respective crossing temperature, at which an entropy parameter mΔS of both respective neighboring magnetocaloric material layers assumes the same crossing-point value, the entropy parameter mΔS being defined as a product of the mass m of the respective magnetocaloric material layer and an amount of its isothermal magnetic entropy change ΔS in a magnetic phase transition of the respective magnetocaloric material layer,
at least two of the inner layers have masses m differing from each other, and
all crossing-point values of the entropy parameter mΔS of all pairs of next neighboring inner layers are equal, either exactly or within a margin of ±15%, to a mean value of all crossing-point values of all pairs of next neighboring inner layers of the magnetocaloric cascade. The magnetocaloric cascade will hereinafter sometimes be referred to in short as the cascade for reasons of brevity.

The parameter ΔS is a measure of an amount of isothermal magnetic entropy change to that is achievable in a magnetic phase transition of the respective magnetocaloric material layer. The amount of isothermal magnetic entropy change can be determined by techniques known in the art, for instance by deduction from isothermal magnetization data or by deduction from isofield heat capacity data. It is a function of temperature. It may be quantified for instance in units of J/cm³/K or, more commonly, J/kg/K. For reasons of simplicity, even though an amount is meant in the present context, the parameter is not denoted herein by ∥ΔS∥, but by ΔS. The parameter ΔS quantifies a characteristic of a given magnetocaloric material layer and thus forms a parameter that is individually controllable layer per layer by proper design of the magnetocaloric cascade. Typically, a maximum amount ΔSₘₐₓ of the isothermal magnetic entropy change is achievable at the Curie temperature T_{C} of a given magnetocaloric material.

The product of ΔS and mass for a given layer is herein referred to as “the entropy parameter” only for ease of reference within the present specification. However, this is not meant to define entropy. The entropy parameter may be described as a mass-weighted isothermal magnetic entropy change in a magnetic phase transition. For even shorter reference the entropy parameter is also referred to as mΔS.

The present invention recognizes the significance of the entropy parameter mΔS of the inner layers for improving the performance of the magnetocaloric cascade in pumping heat between a hot side and a cold side. The present invention further recognizes that real magnetocaloric materials each have a respective individual temperature dependence of the entropy parameter, typically exhibiting an individual global maximum amount mΔSₘₐₓ for each layer at the respective Curie temperature. The present invention establishes that an improvement in the heat-pumping power of a magnetocaloric cascade is possible by suitably adjusting the entropy parameter mΔS across the inner layers of the magnetocaloric cascade. In providing that at least two of the inner layers have masses m differing from each other such that all crossing-point values of the entropy parameter mΔS of all pairs of next neighboring inner layers are equal, either exactly or within a margin of ±15%, to a mean value of all crossing-point values of all pairs of next neighboring inner layers of the magnetocaloric cascade, the present invention provides a layer design of a magnetocaloric cascade that exhibits improved heat-pumping power in comparison with known layer designs.

In the following, embodiments of the magnetocaloric cascade of the first aspect of the to invention will be described.

The margin of variation of the crossing-point values of the entropy parameter mΔS of all pairs of next neighboring inner layers with respect to the mean value of all crossing-point values of all pairs of next neighboring inner layers of the magnetocaloric cascade is in some embodiments even smaller than ±15%, In some embodiments, the margin is ±10%, and in others even only ±5%. The smaller the margin of variation, the higher tends to be the achieved improvement in the performance of the magnetocaloric cascade in pumping heat between a hot side and a cold side.

The magnetocaloric cascade can be implemented with any suitable combination of magnetocaloric material layers. To achieve a high heat-pumping power in operation of the cascade, it is advantageous if different magnetocaloric material layers of the cascade exhibit respective materials and respective masses which in combination provide the crossing-point values of the entropy parameter mΔS across the magnetocaloric cascade at a value that is as high as can be achieved, in addition to being equal or differ only within the mentioned margin.

Due to different material properties, the temperature dependences of the entropy parameter exhibit line shapes that may differ considerably in their respective maximum amount mΔSₘₐₓ and in their width, for instance to be determined as a full width at half maximum (FWHM) with respect to the maximum amount mΔSₘₐₓ. A suitable choice of materials of the magnetocaloric cascade in this regard takes into account the Curie-temperature difference amount ΔT_{C} (also referred to as the Curie temperature spacing) between neighboring layers of the cascade. The smaller the Curie temperature spacing between two neighboring magnetocaloric layers of the cascade, the higher is typically the crossing-point value of the entropy parameter for these two layers. Furthermore, a width measure characterizing a function describing the temperature dependence of the entropy parameter mΔS forms a suitable parameter for influencing the amount of the crossing-point value of the entropy parameters of neighboring magnetocaloric materials in design of the cascade. For instance, for a given Curie-temperature spacing, increasing a full width at half maximum (FWHM) of the temperature dependence of the entropy parameter mΔS of at least one of two neighboring layers by suitable material selection typically increases the crossing-point value of the entropy parameter for two neighboring magnetocaloric materials in the cascade (assuming for simplicity of explanation that the maximum amount mΔSₘₐₓ does not change). The Curie temperature spacing and the FWHM cannot only be determined by material selection from a given discrete set of materials. In some material systems, these parameters can be adapted quasi continuously by selecting a suitable composition of the magnetocaloric materials for the respective magnetocaloric layers. Several material systems covering different constituent elements in ranges of stoichiometries are known. Example material systems are MnFePAs, MnAsSb, and MnFePSiGe. Such material systems offer a substantially continuous coverage of a range of Curie temperatures. A Curie temperature that is suitable for a particular magnetocaloric layer in a cascade design can be achieved by setting a proper stoichiometry of the constituent elements of the material within the material system. On the other hand, a broadening of the FWHM of the temperature dependence of the entropy parameter can for instance be achieved by mixing materials with slightly different stoichiometries into a single layer or by providing a magnetocaloric material layer with a sublayer structure, wherein the sublayers have slightly different stoichiometries, instead of a magnetocaloric layer of equal thickness and homogenous composition.

In some embodiments of the cascade of the present invention, magnetocaloric layers from different material systems are used in the cascade. These embodiments provide particularly high design flexibility for implementing the cascade design in accordance with the present invention. It is noted that magnetocaloric materials having a difference in their chemical constituents or stoichiometric composition are considered identical materials in the context of the present disclosure, provided that their material parameters relevant for implementing the magnetocaloric cascade in accordance with a given embodiment of the present invention assume identical values.

In some embodiments, which will be discussed in more detail further below, neither the hot-side outer layer nor cold-side outer layer fulfils the crossing-point-value requirement that applies to the inner layers in accordance with the present invention. For clarity of reference, these embodiments will be referred to as the first group in the next paragraph. However, it is noted that in other embodiments of the cascade, it is not only the inner layers that exhibit this particular design with respect to the crossing-point values of the entropy parameter mΔS. In addition, (in a second group of embodiments) a cold-side outer layer pair formed by the cold-side outer layer and its next neighboring cold-side inner layer, or (in a third group of embodiments) a hot-side outer layer pair formed by the hot-side outer layer and its next neighboring hot-side inner layer, or (in a fourth group of embodiments) the hot-side and the cold-side outer layer pair also exhibit a crossing-point value of the entropy parameter mΔS that is equal, either exactly or within the margin of ±15%, to the mean value of all crossing-point values of all pairs of next neighboring inner layers of the magnetocaloric cascade.

Turning now to the first to third group of embodiments mentioned in the last paragraph, a further operational improvement can achieved by an additional layer design measure. In that context, as is well known per se, each pair of next neighboring magnetocaloric layers has a respective Curie-temperature difference amount ΔT_{C} between their respective Curie temperatures. According to the additional design measure, the hot-side outer layer or the cold-side outer layer exhibits a larger ratio mΔSₘₐₓ/ΔT_{C} of the maximum of the entropy parameter mΔS and the Curie-temperature difference amount ΔT_{C} in comparison with any of the inner layers. The magnetocaloric cascade of this type of embodiment further improves the performance of a magnetocaloric cascade in a magnetocaloric regenerator of a heat-pump in comparison with known magnetocaloric cascades by providing its hot-side outer layer or its cold-side outer layer (or both) with a larger ratio of mΔSₘₐₓ/ΔT_{C} than any of the inner layers.

The parameter mΔSₘₐₓ forms the maximum of the entropy parameter mΔS. In other words, it is a measure of an absolute maximum of the amount of isothermal magnetic entropy change that is achievable in a magnetic phase transition of the respective magnetocaloric material layer having a given mass m. For many magnetocaloric materials, the maximum amount of the isothermal magnetic entropy change is achievable at the Curie temperature T_{C} of the given magnetocaloric material. The parameter mΔSₘₐₓ is unambiguously defined for a given layer of a given mass and a given material composition due to a characteristic line shape of the temperature dependence of ΔS. A magnetocaloric material therefore only has a single ΔSₘₐₓ. Typically, different magnetocaloric materials have different values of ΔSₘₐₓ. Modifying the mass of a given layer can not only be used to adapt the crossing-point value of the entropy parameter mΔS with respect to a neighboring layer, but also to adapt the maximum mΔSₘₐₓ.

The parameter ΔT_{C} denotes a difference amount between Curie temperatures of a given layer and one next neighboring magnetocaloric material layer. Here, the respective Curie temperatures as measurable in absence of any applied magnetic field are meant. While the Curie temperature T_{C} is a parameter that quantifies a characteristic of a given magnetocaloric layer, the parameter ΔT_{C} describes a property of a given layer sequence of two layers, namely, a given layer and its next neighboring magnetocaloric layer of the cascade. As such, the parameter ΔT_{C} reaches beyond a given individual layer. It relates to the design of the sequence of layers in the magnetocaloric cascade.

Regarding the definition of ΔT_{C}, the following is noted: For reasons of simplicity, even though an amount is meant, the parameter is not denoted by ∥ΔT_{C}∥, but by ΔT_{C} Furthermore, an ambiguity may be seen on first sight in the above definition of ΔT_{C}. For an inner layer of the cascade, two different values of the parameter ΔT_{C} could in principle be to determined, because an inner layer has two next neighboring layers, one on each side.

However, when comparing the parameter values of ΔT_{C} within a cascade, no such ambiguity occurs because there is an order of determination of ΔT_{C} along one of the two possible directions along the cascade. Suitably, the order of determination follows the direction of heat flow through the cascade, which depends on a given application case (cooling or heating). In any case, the set of values of ΔT_{C} across a given cascade is identical irrespective of the order of determination. For the hot-side layer and the cold-side layer, of course, there is only one next neighboring layer because the hot-side layer and the cold-side layer form the outer layers of the cascade.

Maximizing the parameter mΔSₘₐₓ/ΔT_{C} at the hot-side layer or the cold-side layer of the cascade in comparison with the inner layer(s) of the cascade in embodiments further improves the performance of the cascade as a whole, as will be shown further below by way of examples. The achieved effect can also be described as a strengthening of the cascade at its respective outer end facing a hot side or a cold side of a heat pump. An improvement is already achieved with a relatively small difference of mΔSₘₐₓ/ΔT_{C} in one of the hot side or cold-side outer layers in comparison with the inner layers. The advantageous effect of the present embodiment on the heat pumping capacity of the magnetocaloric cascade in comparison with known cascade designs becomes particularly strong towards higher temperature spans between the hot and cold sides of the cascade. This temperature span typically finds an at least approximate correspondence in the difference between the Curie temperatures of the hot-side outer layer and the cold-side outer layer. In comparison with prior-art designs for a given temperature span, such embodiments achieve heat pumping with improved performance also at temperature differences considerably larger than the nominal temperature span.

Preferably, the hot-side outer layer or the cold-side outer layer exhibits an amount of the ratio mΔSₘₐₓ/ΔT_{C} that is at least 1% larger in comparison with any of the inner layers. In other embodiments, mΔSₘₐₓ/ΔT_{C} is larger by at least 5% at the hot-side outer layer or the cold-side outer layer than at any of the at least one inner layers. In another embodiment, the parameter mΔSₘₐₓ/ΔT_{C} is larger at the hot-side outer layer or the cold-side outer layer than at any of the at least one inner layers by at least 10%. In one embodiment, the hot-side outer layer or the cold-side outer layer exhibits an amount of the ratio mΔSₘₐₓ/ΔT_{C} that is at least 20% larger in comparison with any of the inner layers. In yet another embodiment, the hot-side outer layer or the cold-side outer layer exhibits an amount of the ratio ΔSₘₐₓ/ΔT_{C} that is no more than 150%, in other embodiments no more than 100% larger in comparison with any of the inner layers. The heat-pumping-power improvement increases almost in proportion with increasing the percentage by which the ratio mΔSₘₐₓ/ΔT_{C} is higher at the hot-side outer layer or the cold-side outer layer than at the inner layers. However, increasing the ratio by selecting a magnetocaloric material with a higher maximum ΔSₘₐₓ of the entropy parameter requires attention to the line-width (FWHM) of the temperature dependence of ΔS of the selected material so as to achieve a high crossing-point value in combination with a given neighboring layer.

In three alternative embodiments of the magnetocaloric cascade, the strengthening measures described above with respect to the outer layers of the cascade concern a) the hot-side outer layer alone or b) the cold-side outer layer alone, or c) both the hot-side outer layer and the cold-side outer layer. Thus, when stating that the hot-side outer layer or the cold-side outer layer exhibits a larger ratio mΔSₘₐₓ/ΔT_{C} in comparison with any of the inner layers, the term “or” is to be understood as including all three mentioned alternatives.

In some embodiments of the magnetocaloric cascade representing the third mentioned alternative, therefore, the hot-side outer layer and the cold-side outer layer exhibit the same value of the ratio mΔSₘₐₓ/ΔT_{C}. This achieves a particularly strong improvement with respect to the performance of the magnetocaloric cascade. In similar embodiments, one of the hot-side and cold-side outer layers has a higher amount of the ratio mΔSₘₐₓ/ΔT_{C} than the other. In some of these other embodiments, the other of the hot-side and cold-side outer layers has a higher amount of the ratio mΔSₘₐₓ/ΔT_{C} than any of the at least one inner layer.

Different measures for adapting the maximum amount of the entropy parameter mΔS ΔT_{C}, i.e., mΔSₘₐₓ/ΔT_{C}, can be used, either alone or in combination with each other, for accomplishing the design of suitable embodiments of the cascade.

One such measure implemented in some embodiments is increasing the amount of ΔSₘₐₓ in comparison with any of the inner layers. A variation of ΔSₘₐₓ can for instance be achieved by proper material choice, of course taking into account requirements of a given application case regarding the Curie temperature. The hot-side outer layer or the cold-side outer layer of some variants of this type of embodiment exhibits an amount of ΔSₘₐₓ that is larger by at least 2% in comparison with any of the inner layers. An even larger effect is achieved in other variants having an amount of ΔSₘₐₓ in the hot-side outer layer or the cold-side outer layer that is larger by at least 10% in comparison with any of the inner layers. An upper limit of increasing ΔSₘₐₓ in the hot-side outer layer or the cold-side outer layer over the inner layers is at approximately 50% in comparison with any of the inner layers.

In accordance with another measure that can be used in the alternative or in combination with the mentioned measure, the hot-side outer layer or the cold-side outer layer exhibits a smaller amount of ΔT_{C} in comparison with any of the inner layers. As is known per se, in material systems of magnetocaloric materials a variation of ΔT_{C} can for instance be achieved by adaptation of stoichiometry, i.e., the different fractions of the constituent elements in the material composition within the given material system for designing a given layer of the cascade. In a further embodiment of the magnetocaloric cascade, the hot-side layer or the cold-side layer exhibits an amount of ΔT_{C} that is at least 0.2% smaller in comparison with those any of the at least one inner layer. In another embodiment of the magnetocaloric cascade, the hot-side layer or the cold-side layer exhibits an amount of ΔT_{C} that is at least 5% smaller in comparison with those any of the at least one inner layer. However, with regard to the lower end of preferred amounts of ΔT_{C}, the hot-side layer or the cold-side layer preferably exhibits an amount of ΔT_{C} that is no less than 0.25K, preferably no less 0.5K.

Another design parameter that is used in some embodiments to influence the crossing-point values of the entropy parameter ΔS is the line width of its temperature dependence, for instance the full width at half the maximum amount (ΔSₘₐₓ), to be determined in units of K. To increase a large line width and thus increase the crossing-point value for a given pair of neighboring magnetocaloric layers, a mix of different magnetocaloric layers can be used in at least one of the layers. In some such embodiments, a sublayer sequence can be used, preferably one that does not reduce the maximum amount ΔSₘₐₓ of the mix or sublayer sequence in comparison with a single layer.

In one such embodiment suitable for further increasing the strength of at least one of the outer layers, the hot-side outer layer or the cold-side outer layer or both comprise a sublayer sequence of at least two hot-side sublayers or cold-side sublayers, respectively. This way, a grading of the Curie temperature within the respective outer layer can be achieved, which further improves the heat-pumping effectiveness at the respective outer layer.

As mentioned, each of the parameters mass, ΔSₘₐₓ and ΔT_{C} may be varied in any of the layers alone or in combination to adapt a crossing-point value, and/or to adapt the maximum amount of mΔSₘₐₓ/ΔT_{C} at the hot-side or cold-side outer layer and/or its next neighboring inner layers of the cascade.

Magnetocaloric material systems, from which materials for use in any of the embodiments of the magnetocaloric cascade can be selected in accordance with the respective requirements of the embodiments described herein, are for instance disclosed in WO 2014/115057A1, page 11, line 26, to page 14, line 31. The publication WO 2014/115057A1 as a whole is hereby incorporated by reference into the present specification.

According to a second aspect of the present invention, a magnetocaloric regenerator is provided that includes a magnetocaloric cascade according to the first aspect of the present invention or one of its embodiments.

The magnetocaloric regenerator shares the advantages of the magnetocaloric cascade of the first aspect of the invention.

The magnetocaloric regenerator can be implemented in many different embodiments.

Some of these different embodiments comprise the magnetocaloric cascade of the first aspect in respective different shapes. In some embodiments, a plate shape is used. In other embodiments, the magnetocaloric cascade comprises one or more channels extending through the magnetocaloric cascade for accommodating a heat transfer fluid, or a plurality of microchannels. The magnetocaloric generator may comprise the magnetocaloric material layers in respective different material shapes. A magnetocaloric material layer is in some embodiments formed by a solid material layer or a porous magnetocaloric material layer. In other embodiments it is formed by magnetocaloric particles, which in different embodiments are spherically-shaped, non-spherically shaped such as disk-shaped or irregularly-shaped compounds. Spherically-shaped particles of different embodiments have a diameter of between 50 and 500 micrometer, in some embodiments the diameter is approximately 100 micrometer. The particle layers are typically formed under pressure and using a binding substance. In currently preferred embodiments, the regenerator comprises packed beds of particle layers.

According to a third aspect of the present invention a heat pump comprising a magnetocaloric regenerator according to the second aspect of the invention or one of its embodiments is provided. The heat pump shares the advantages of the magnetocaloric regenerator of the second aspect of the invention.

In the following, embodiments of the heat pump will be described.

Embodiments of the heat pump are suitably configured to cyclically perform a pumping sequence including a temperature increase and a temperature decrease of the heat-pump working body.

The heat pump of further suitable embodiments further comprises a hot-side interface in thermal communication with the hot-side outer layer, a cold-side interface in thermal communication with the cold-side outer layer, and a heat transfer system, which is configured to provide a flow of a heat-transfer fluid between the hot-side interface and the cold side interface through the magnetocaloric cascade, wherein the Curie temperature of the hot-side outer layer is selected to be higher than a temperature of the hot-side interface in operation of the heat pump, or the Curie temperature of the cold-side outer layer is selected to be lower than a temperature of the cold-side interface in operation of the heat pump. In a cooling application, for example, the cold-side interface is configured to be in thermal contact with an object to be cooled, and the hot-side interface is configured to be in thermal contact with a heat sink.

According to a fourth aspect of the present invention, a method for fabricating a magnetocaloric cascade is provided. The method comprises
fabricating a sequence of different magnetocaloric material layers having different Curie temperatures T_{C}, wherein the magnetocaloric material layers include a cold-side outer layer, a hot-side outer layer and at least three inner layers between the cold-side outer layer and the hot-side outer layer;
fabricating at least two of the inner layers with masses m differing from each other, wherein
for each pair of next neighboring magnetocaloric material layers of the magnetocaloric cascade there exists a respective crossing temperature, at which an pumping power entropy parameter mΔS of both respective neighboring magnetocaloric material layers assumes the same crossing-point value, the entropy parameter mΔS being defined as a product of the mass m of the respective magnetocaloric material layer and an amount of its isothermal magnetic entropy change ΔS in a magnetic phase transition of the respective magnetocaloric material layer;
and wherein
all crossing-point values of the entropy parameter mΔS of all pairs of next neighboring inner layers are equal, either exactly or within a margin of ±15%, to a mean value of all crossing-point values of all pairs of next neighboring inner layers across the magnetocaloric cascade.

The method of the fourth aspect of the invention achieves the advantages described hereinabove in the context of the magnetocaloric cascade of the first aspect of the invention. Embodiments of the method involve fabricating a cascade so as to further include the additional features its embodiments as described in the context of the first aspect of the invention.

In one embodiment of the method each pair of next neighboring magnetocaloric layers has a respective Curie-temperature difference amount ΔT_{C} between their respective Curie temperatures, and the hot-side outer layer or the cold-side outer layer is fabricated to exhibit a larger ratio mΔSₘₐₓ/ΔT_{C} of the maximum of the entropy parameter mΔS and the Curie-temperature difference amount ΔT_{C} in comparison with any of the inner layers.

According to a fifth aspect of the invention, a heat-pumping method comprises
performing a heat-pumping sequence using a magnetocaloric regenerator comprising a magnetocaloric cascade according to the first aspect of the invention or one of its embodiments.

In the following, embodiments of the heat-pumping method will be described.

In one embodiment, the pumping sequence includes a temperature increase of the magnetocaloric cascade which is performed in thermal communication with a heat sink. The pumping sequence is performed using a magnetocaloric cascade with the hot-side outer layer being a magnetocaloric layer with a Curie temperature that is between 0.5 K and 5 K higher than a heat-sink temperature.

Further embodiments are disclosed in the enclosed claims.

In the following, further embodiments will be described with reference to the enclosed drawings. In the drawings:

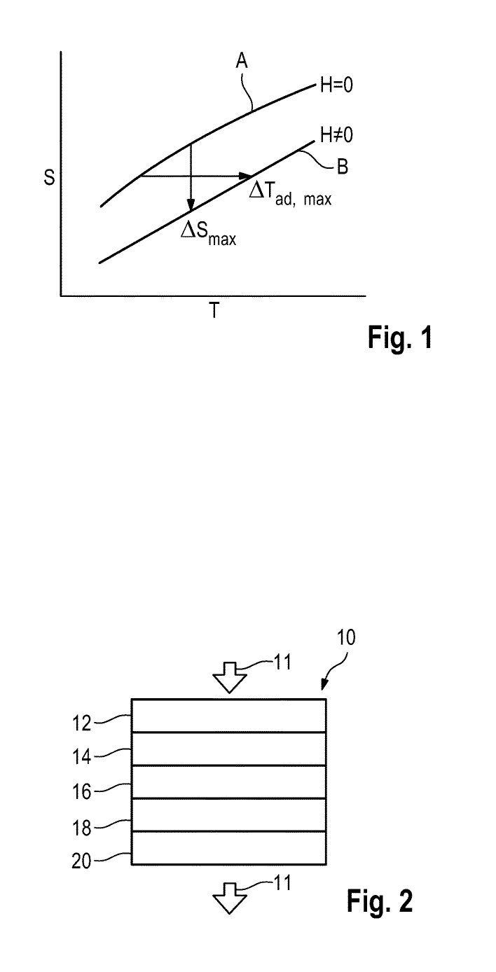

FIG. 1 shows a schematic diagram illustrating a difference in a dependence of magnetic entropy on temperature for the cases of exposure and non-exposure of a magnetocaloric material to a magnetic field near its Curie temperature;

FIG. 2 shows an embodiment of a magnetocaloric cascade;

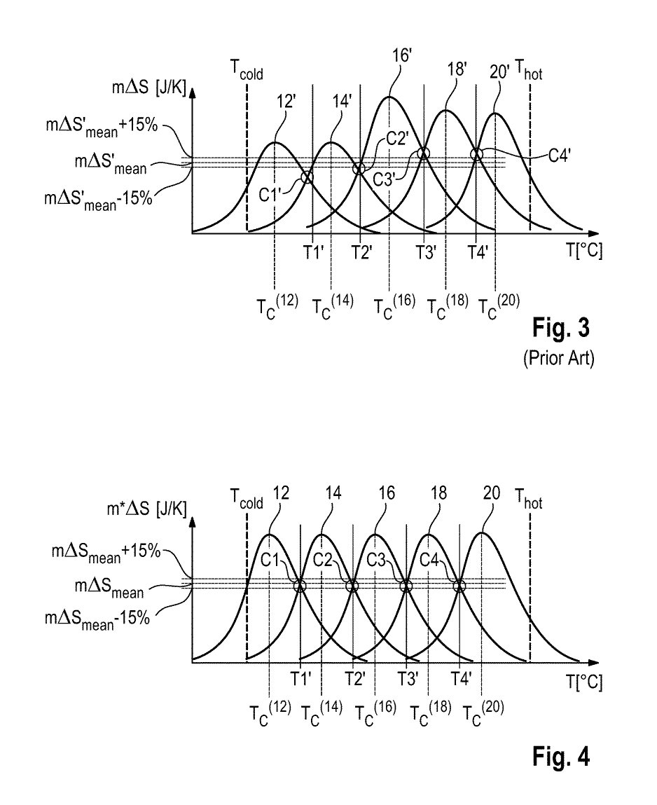

FIG. 3 shows an illustration of a temperature dependence of an isothermal magnetic entropy change ΔS in a magnetic phase transition of respective magnetocaloric material layers of a cascade in accordance with the prior art;

FIG. 4 shows an illustration of a temperature dependence of the mass-weighted isothermal magnetic entropy change in a magnetic phase transition (i.e., the entropy parameter) of the respective magnetocaloric material layers of the cascade of FIG. 2;

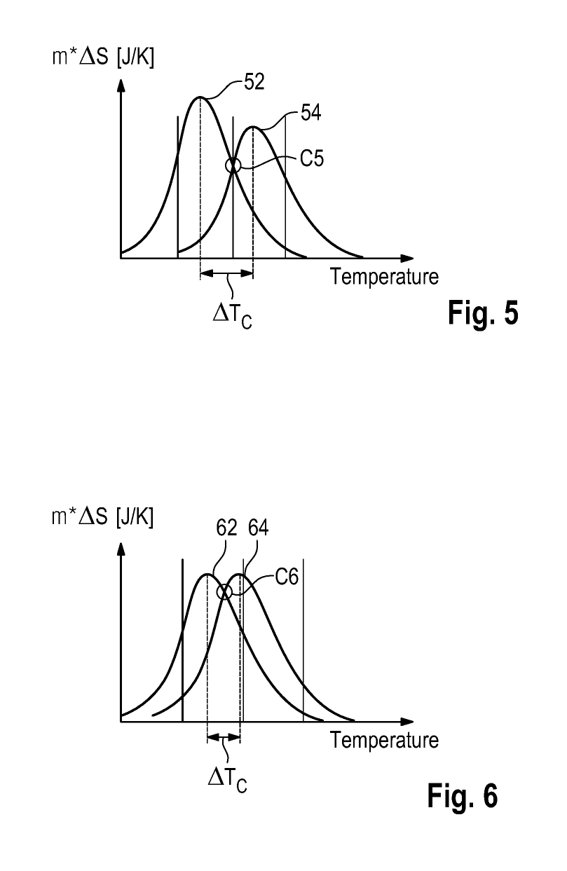

FIGS. 5 and 6 are illustrations of the temperature dependence of the mass-weighted isothermal magnetic entropy change in a magnetic phase transition (i.e., the entropy parameter) of two next neighboring magnetocaloric material layers in two different embodiments of a magnetocaloric cascade;

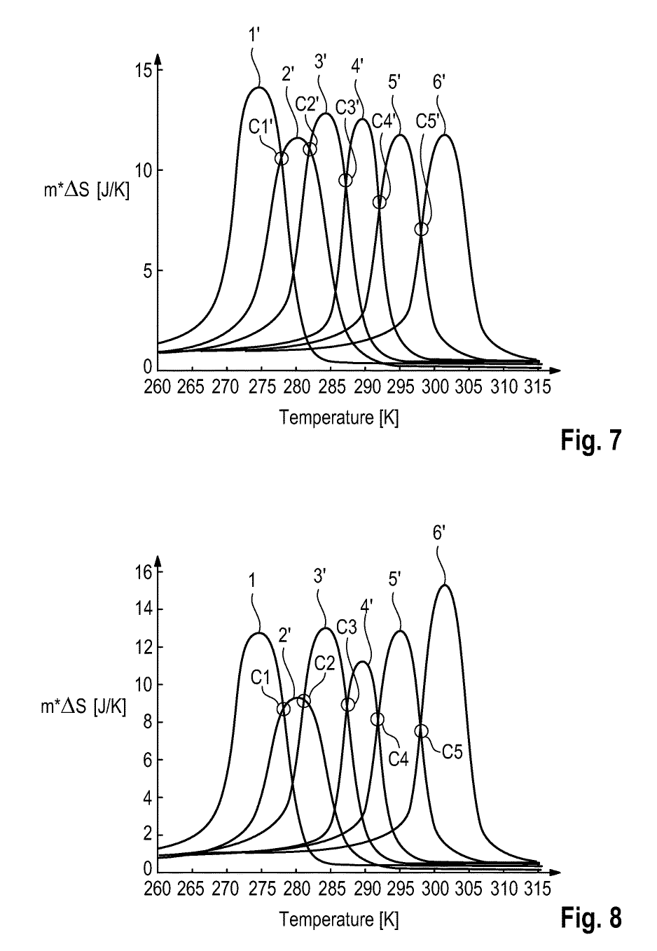

FIG. 7 shows an illustration of a temperature dependence of the mass-weighted isothermal magnetic entropy change in a magnetic phase transition (i.e., the entropy parameter) of the respective magnetocaloric material layers of a reference cascade, which is used as an illustrative example of a cascade that is not in accordance with the present invention.

FIG. 8 shows, for comparison, an illustration of a temperature dependence of the mass-weighted isothermal magnetic entropy change in a magnetic phase transition (i.e., the entropy parameter) of the respective magnetocaloric material layers of an embodiment according to the present invention.

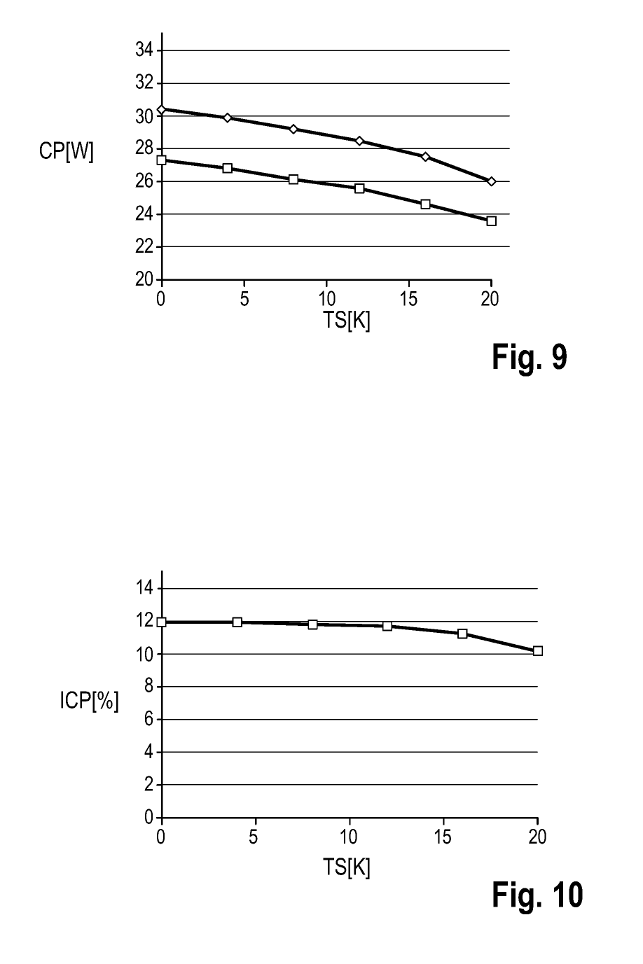

FIG. 9 is a diagram showing the cooling power (CP, in units of Watt) of the cascades of FIG. 7 and FIG. 8 as a function of the temperature span (TS) between the hot-side outer layer and the cold-side outer layer (in units of Kelvin).

FIG. 10 shows a diagram illustrating an improvement in cooling power (abbreviated as ICP) of the embodiment of the magnetocaloric cascade of FIG. 8 in comparison with the reference cascade of FIG. 7 for different temperature spans between a hot-side temperature and a cold-side temperature.

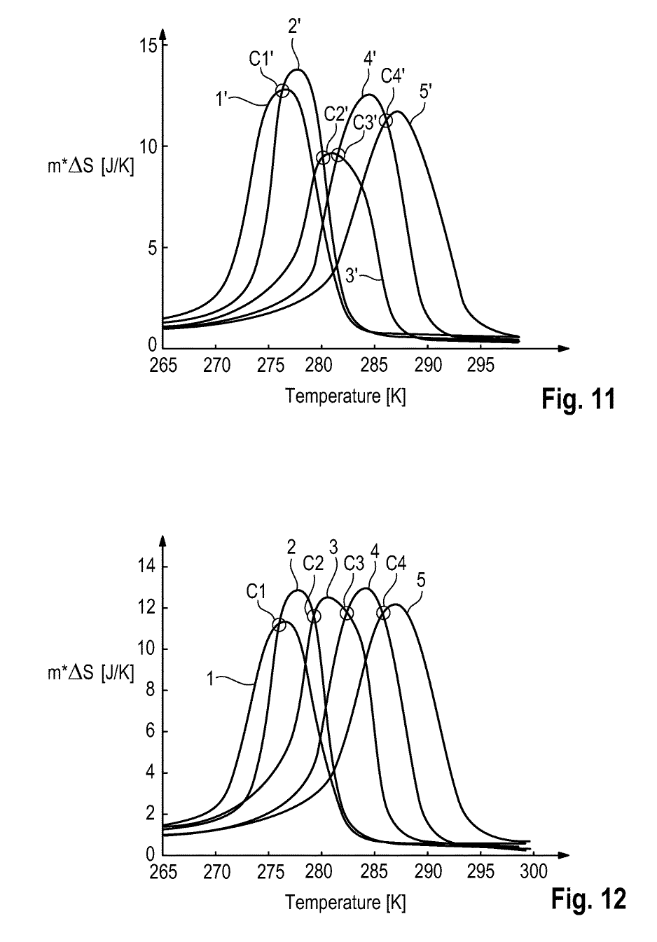

FIG. 11 shows an illustration of a temperature dependence of the mass-weighted isothermal magnetic entropy change in a magnetic phase transition (i.e., the entropy parameter) of the respective magnetocaloric material layers of a reference cascade, which is used as an illustrative example of a cascade that is not in accordance with the present invention.

FIG. 12 shows, for comparison with FIG. 11, an illustration of a temperature dependence of the mass-weighted isothermal magnetic entropy change in a magnetic phase transition (i.e., the entropy parameter) of the respective magnetocaloric material layers of an embodiment according to the present invention.

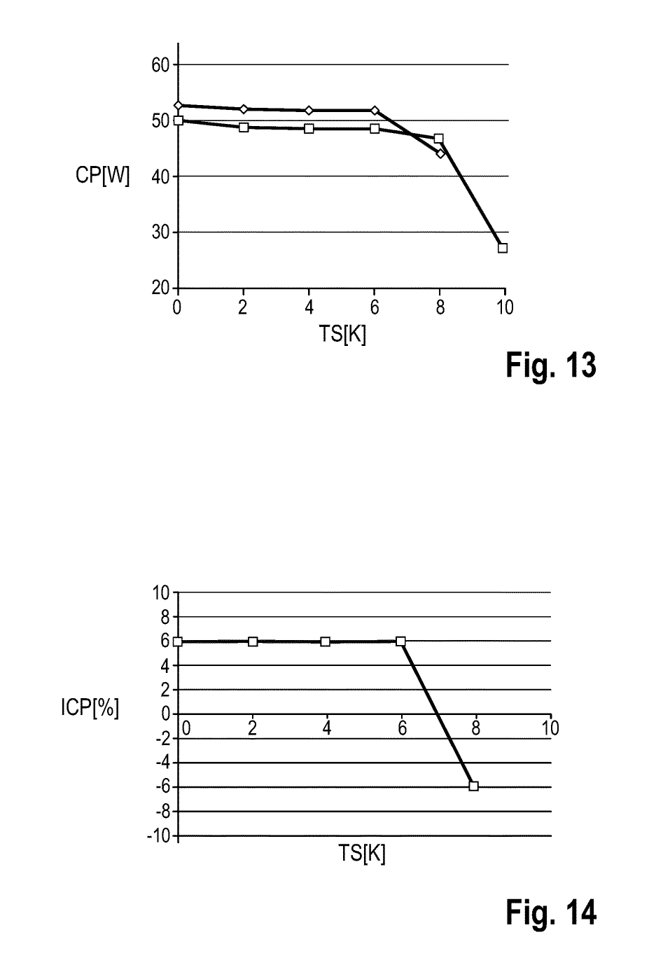

FIG. 13 is a diagram showing the cooling power (CP, in units of Watt) of the cascades of FIG. 11 and FIG. 12 as a function of the temperature span (TS) between the hot-side outer layer and the cold-side outer layer (in units of Kelvin).

FIG. 14 shows a diagram illustrating an improvement in cooling power (abbreviated as ICP) of the embodiment of the magnetocaloric cascade of FIG. 12 in comparison with the reference cascade of FIG. 11 for different temperature spans between a hot-side temperature and a cold-side temperature.

FIG. 1 shows a diagram in which an entropy S is plotted in linear units (Joule/Kelvin) as a function of temperature T, also in linear units of Kelvin for a magnetocaloric material layer. The curves shown in the diagram are also referred to as ST curves. The diagram is purely schematic and only serves to illustrate the following. The magnetocaloric material layer exhibits different ST curves under application of magnetic fields of different amounts. Two exemplary curves A and B illustrate the cases H=0 (no magnetic field applied) and H≠0 (application of a magnetic field of a certain amount). The ST curve of the case H=0 is found at higher entropy levels, which is due to the higher contribution of the magnetic entropy to the shown overall entropy of the magnetocaloric material layer. Further contributions to the entropy S are provided by the crystal lattice and by the electrons of the magnetocaloric material of the layer. Under application of the magnetic field that is strong enough to cause a phase transition of the magnetocaloric material layer leading to an orientation of all magnetic moments along the direction of the magnetic field vector the magnetic entropy at the given temperature drops by an amount ΔSₘₐₓ. This gives rise to a temperature increase. A maximum of the temperature increase in an adiabatic process amounts to ΔT_{ad, max} and occurs at a temperature that is different from that, at which ΔSₘₐₓ is observable, as shown in FIG. 1.

In the following, reference is made in parallel to FIGS. 2 to 4. FIG. 2 shows an embodiment of a magnetocaloric cascade 10 for use as a magnetocaloric regenerator, and thus as a working body of a cooling device for pumping heat in a direction indicated by arrows 11. FIG. 3 shows an illustration of a temperature dependence of an isothermal magnetic entropy change ΔS in a magnetic phase transition of respective magnetocaloric material layers of the cascade of FIG. 2. FIG. 4 shows an illustration of a temperature dependence of the mass-weighted isothermal magnetic entropy change in a magnetic phase transition (i.e., the entropy parameter) of the respective magnetocaloric material layers of the cascade of FIG. 2.

The cascade 10 is formed of a layer sequence of magnetocaloric material layers 12 to 20. In particular, the cascade has a cold-side outer layer 12 followed by a plurality of magnetocaloric inner layers, of which the inner layers 14, 16 and 18 are provided in the present example. Furthermore, the cascade has a hot-side outer layer 20. The layer pair (12,14) formed by the cold-side outer layer 12 and the next neighboring inner layer 14 is herein also referred to as the cold-side outer layer pair. The layer pair (18, 20) formed by the hot-side outer layer 20 and the next neighboring inner layer 18 is herein also referred to as the hot-side outer layer pair.

The layer sequence of the magnetocaloric cascade 10 has the following particular feature illustrated by way of FIGS. 3 and 4: first, FIG. 3 shows FIG. 3 shows a schematic illustration of a temperature dependence of an mass-weighted isothermal magnetic entropy change ΔS in a magnetic phase transition of respective magnetocaloric material layers of a cascade in accordance with the prior art. The magnetocaloric cascade underlying the illustration of FIG. 3 has five magnetocaloric material layers similar to the structure of FIG. 2. The magnetocaloric layers are referred to as 12′ to 20′. However, the magnetocaloric cascade referred to in FIG. 3 is a structure in accordance with the prior art, as will become clear from the following explanation.

The different magnetocaloric material layers 12 to 20 have identical masses and different Curie temperatures T_{C}, which in FIG. 3 are labelled with a view to the respective reference labels of the corresponding layers as T_{C}⁽¹²⁾, T_{C}⁽¹⁴⁾, T_{C}⁽¹⁶⁾, T_{C}⁽¹⁸⁾ and T_{C}⁽²⁰⁾ in a sequence of gradually increasing values between the cold-side outer layer 12′ and the hot-side outer layer 20′. For each pair of next neighboring magnetocaloric material layers of the magnetocaloric cascade, i.e., for the layer pairs (12, 14), (14, 16), (16, 18) and (18, 20) there exists a respective crossing temperature T1′, T2′, T3′, and T4′, at which the product mΔS of layer mass and isothermal magnetic entropy change ΔS in a magnetic phase transition of the respective magnetocaloric material layer is identical for both respective neighboring magnetocaloric material layers. The corresponding crossing points are labelled as C1′, C2′, C3′ and C4′. A mean crossing point value mΔS′ₘₑₐₙ of all pairs of next neighboring inner layers, i.e., layer pairs (14, 16) and (16, 18) can be calculated and is indicated in the diagram of FIG. 3. As FIG. 3 shows, the values of mΔS at the crossing points C1′, C2′, C3′ and C4′ are different. In particular, the crossing point values of mΔS at C2′ and C3′ for the pairs (14, 16) and (16, 18) of inner layers are outside a margin of ±15% around the mean ^{value mΔS′}ₘₑₐₙ of all crossing-point values of all pairs of next neighboring inner layers of the magnetocaloric cascade. The upper and lower limits of the margin around the mean crossing point value mΔS′ₘₑₐₙ are labelled mΔS′ₘₑₐₙ+15% and mΔs′ₘₑₐₙ−15% in FIG. 3, meaning mΔs′ₘₑₐₙ+0.15*mΔs′ₘₑₐₙ and mΔs′ₘₑₐₙ−0.15*mΔs′ₘₑₐₙ. It is noted that the diagram is schematic and may therefore not show values to scale.

In contrast, FIG. 4 shows an illustration of a temperature dependence of the mass-weighted isothermal magnetic entropy change in a magnetic phase transition (i.e., the entropy parameter) of the respective magnetocaloric material layers of the cascade of FIG. 2. It is assumed that the Curie temperatures of the respective layers, T_{C}⁽¹²⁾, T_{C}⁽¹⁴⁾, T_{C}⁽¹⁶⁾, T_{C}⁽¹⁸⁾ and T_{C}⁽²⁰⁾ are identical to those of the prior-art cascade referred to in FIG. 3. However, this is only for the purpose of simplicity of explanation. As shown in FIG. 4 for the embodiment of FIG. 2, the materials and masses of the different layers 12 to 20 of the cascade 10 are adapted individually to form an embodiment of the present invention. In other words, in the cascade 10, at least two of the magnetocaloric material layers have masses m differing from each other. By suitable material selection and design of the layer masses, identical crossing-point values C1, C2, C3 and C4 of the mass-weighted entropy change, i.e., the entropy parameter mΔS defined hereinabove are achieved. More specifically, the entropy parameter mΔS being defined as a product of the mass m of the respective magnetocaloric material layer and an amount of its isothermal magnetic entropy change ΔS in a magnetic phase transition of the respective magnetocaloric material layer is identical at the crossing temperatures T1, T2, and T3 and T4 and differ from the crossing temperatures T1′, T2′, T3′ and T4′. All crossing-point values C1, C2, C3 and C4 of the entropy parameter mΔS across the magnetocaloric cascade are thus exactly equal in the present embodiment. In other embodiments, they are equal within a margin of ±15%, to the mean value mΔSₘₑₐₙ of all crossing-point values of all pairs of next neighboring inner layers of the magnetocaloric cascade.

It is a particular feature of the present embodiment that in fact all crossing-point values C1, C2, C3 and C4 of the entropy parameter mΔS with respect to next neighboring magnetocaloric layers are identical. This is not a necessary requirement in accordance with the present invention, which only requires all inner layers to have equal crossing-point values of the entropy parameter mΔS with next neighboring inner layers, either exactly or within a margin of ±15%, to the mean value mΔSₘₑₐₙ of all crossing-point values of all pairs of next neighboring inner layers of the magnetocaloric cascade. As will be shown further below, further embodiments in accordance with the present invention have hot-side and cold-side outer layers, which are designed to exhibit crossing point values outside the mentioned margin around mΔSₘₑₐₙ.

As a further particular feature of the present embodiment, the maximum amount of mΔS is equal for all layers. However, this is not a necessary requirement.

Based on the design explained, the cascade 10 achieves a particularly high performance in heat-pumping applications.

FIGS. 5 and 6 are illustrations of the temperature dependence of the mass-weighted isothermal magnetic entropy change in a magnetic phase transition (i.e., the entropy parameter) of two next neighboring magnetocaloric material layers 52, 54 and 62, 64 in two different embodiments of a magnetocaloric cascade according to the present invention. The magnetocaloric cascades referred to in FIGS. 5 and 6 comprise a plurality of magnetocaloric layers. In particular at least three inner layers are provided, which are in accordance with the described requirements regarding equality or margin of the crossing points with respect to the mean value mΔSₘₑₐₙ of all crossing-point values of inner-layer pairs. However, any such information about the further layers of the cascade is omitted in FIGS. 5 and 6 for reasons of simplicity. The two next neighboring magnetocaloric material layers 52, 54 and 62, 64, which are shown, form a respective outer layer pair. In other words, the layers 52 and 62 are hot-side or cold-side outer layers, and will be referred to in short as outer layers in the following. The respective next neighboring layers 54 and 64 form inner layers in the wording of the claims.

The outer layers 52 and 62 of both embodiments are strengthened in these two embodiments of the present invention, as will be explained in the following. In the embodiment of FIG. 5, the outer layer 52 has a higher maximum amount mΔSₘₐₓ of the entropy parameter mΔS in comparison with the next neighboring inner layer 54. This property of the outer layer 52 can be achieved by proper material selection or by suitable setting of the mass of the outer layer 52. Selecting a material and/or a mass for the outer layer 52 that in comparison with the next neighboring inner layer 54 leads to a higher maximum amount mΔSₘₐₓ of the entropy parameter mΔS tends to increase the crossing point value C5 of mΔS of the two curves shown in FIG. 5, given a suitable actual amount of mΔSₘₐₓ and the full width at half maximum of the temperature dependence of the entropy parameter mΔS. In some embodiments implementing the situation of FIG. 5 the crossing point value C5 is outside the margin of ±15% with respect to the mean value mΔSₘₑₐₙ of all crossing-point values of all pairs of next neighboring inner layers of the magnetocaloric cascade. In other embodiments, it falls within this margin, however fulfilling exact equality.

In the embodiment of FIG. 6, the outer layer 62 has the same maximum amount mΔSₘₐₓ of the entropy parameter mΔS in comparison with the next neighboring inner layer 64. However, the materials of the layers are selected so that their Curie temperature spacing ΔT_{C} is smaller in comparison with the embodiment of FIG. 5. This also leads to an increased crossing-point value C6 of the entropy parameter mΔS with reference to its respective highest maximum value across the cascade. Selecting a the Curie-temperature difference between the outer layer 62 and the next neighboring inner layer tends to increase the crossing point value C6 of mΔS of the two curves shown in FIG. 5, given a suitable full width at half maximum of the temperature dependence of the entropy parameter mΔS. In some embodiments implementing the situation of FIG. 6 the crossing point value C6 is outside the margin of ±15% with respect to the mean value mΔSₘₑₐₙ of all crossing-point values of all pairs of next neighboring inner layers of the magnetocaloric cascade. In other embodiments, it falls within this margin, without, however fulfilling exact equality.

Both measures described achieve an improvement of heat-pumping performance.

In the following, further embodiments of cascades will be discussed with reference to FIGS. 7 to 14.

FIGS. 7 to 14 show the results of virtual experiments, which were carried out using a physical model similar to that described by Engelbrecht: “A Numerical Model of an Active Magnetic Regenerator Refrigeration System”, http://digital.library.wisc.edu/1793/7596). A one-dimensional model was employed. The total mass of magnetocaloric material of the cascades was 0.025 kg. The pumped volume per blow was 4×10⁻⁶ m³.

Reference cascades were used in the virtual experiments to demonstrate the advantageous effects on pumping power achieved with the embodiments. In particular, in the reference cascades shown in FIGS. 7 and 11, all magnetocaloric material layers have the same mass. Example 1:

A cooling power was determined for a reference cascade according to FIG. 7 that is not in accordance with present invention and used for comparison only. The reference cascade has the following properties. It comprises a sequence of six magnetocaloric layers 1′ to 6′, exhibiting Curie temperatures corresponding to the maxima of the curves shown in FIG. 7. The layers have the same reference mass, and the total mass of all magnetocaloric layers is 0.025 kg. A pumped volume per blow amounts to 4×10⁻⁶ m³. Only for the purpose of simplified graphical representation, the mass was assumed to be 1 kg per layer for determining the curves in FIGS. 7 and 8. For the actual power calculations shown in FIGS. 9 and 10, the actual mass was used.

The crossing points of the curves of the entropy parameter as a function of temperature are as specified in Table 1:

TABLE 1
Crossing points for reference cascade of FIG. 7

| | C1′ | C2′ | C3′ | C4′ | C5′ |
|---|---|---|---|---|---|
| m * ΔS [J/K] | 10.44 | 10.68 | 9.27 | 8.17 | 7.1 |
| Deviation | 14.3% | 17.0% | 1.5% | −10.5% | −22.3% |
| from mean | | | | | |

The deviations from the mean value given in Table 1 are calculated with respect to a mean value of the crossing points C1′ to C5′, which is 9.17 J/K.

In comparison, the cascade represented by FIG. 8 is based on the same magnetocaloric materials in the different layers 1 to 6. However, some of the layers of the cascade of FIG. 8 have different masses than the corresponding layers of the reference cascade of FIG. 7. The relative masses are given in Table 2, wherein a mass of 1 corresponds to 0.0025 kg divided by the number of layers, i.e., six. The layers are numbered as Layer 1 to Layer 6, which means layer 1′ (cold-side outer layer) to layer 6′ (hot-side outer layer) for the reference cascade of FIG. 7, and layer 1 (cold-side outer layer) to layer 6 (hot-side outer layer) of the embodiment of FIG. 8.

TABLE 2
Relative masses of the layers of the reference cascade and embodiment

| | Layer | | Layer | | Layer | | |
|---|---|---|---|---|---|---|---|
| | 1 | Layer 2 | 3 | Layer 4 | 5 | Layer 6 | Sum |
| Reference, | 1 | 1 | 1 | 1 | 1 | 1 | 6 |
| FIG. 7 | | | | | | | |
| Embodiment, | 0.9 | 0.8 | 1 | 0.9 | 1.1 | 1.3 | 6 |
| FIG. 8 | | | | | | | |

With the mass changes of layers 1, 2, 4, 5 and 6 in the embodiment of FIG. 8 in comparison with the reference cascade of FIG. 7, as shown in Table 2, the following crossing point values are achieved for the embodiment of FIG. 8:

TABLE 3
Crossing points for the cascade embodiment of FIG. 8

| | C1 | C2 | C3 | C4 | C5 |
|---|---|---|---|---|---|
| m * ΔS [J/K] | 8.55 | 9.04 | 8.79 | 8.24 | 8.48 |
| Deviation | −0.8% | 4.9% | 2.0% | −4.4% | −1.6% |
| from mean | | | | | |

The deviations from the mean value given in Table 1 are calculated with respect to a mean value of the crossing points C1 to C5, which is 8.62 J/K.

The cooling power was determined for the reference cascade of FIG. 7 and for the embodiment of the cascades of the present invention of FIG. 8. FIG. 9 is a diagram showing the cooling power (CP, in units of Watt) of the cascades of FIG. 7 and FIG. 8 as a function of the temperature span (TS) between the hot-side outer layer and the cold-side outer layer (in units of Kelvin). Different symbols used represent different cascades: the CP values obtained for the embodiment of FIG. 8 are represented by full squares, and the CP values obtained for the reference cascade (FIG. 7) are represented by full diamonds. The cooling power of the embodiment of FIG. 8 is clearly higher than that of the reference cascade of FIG. 7 for all temperature spans. FIG. 10 shows an improvement of the cooling power (ICP) of the embodiment of FIG. 8 in units of percent in relation to the cooling power of the reference cascade described above (FIG. 7) for an operating temperature at the hot-side interface of the cascade of 23.9° C. for different temperature spans TS in units of K, i.e., different operating temperatures at the cold-side interface of the cascade, in the range of temperatures spans TS between 0 and 20 K. The temperature values used for determining the respective temperature spans are to be taken at the hot-side and cold-side entry points into the cascade.

The diagrams of FIG. 9 and FIG. 10 clearly show a significant improvement in cooling power of the magnetocaloric cascade of the embodiment of FIG. 8 in comparison with the reference cascade of FIG. 7 in the full range of temperature spans TS between 0 and 20 K. The improvement is almost the same for all temperature spans.

### Example 2

A cooling power was determined for a reference cascade according to FIG. 11 that is not in accordance with present invention and used for comparison only. The reference cascade has the following properties. It comprises a sequence of five magnetocaloric layers 1′ to 5′, exhibiting Curie temperatures corresponding to the maxima of the curves shown in FIG. 11. The layers have the same reference mass, and the total mass of all five magnetocaloric layer is 0.025 kg. A pumped volume per blow amounts to 4×10⁻⁶ m³. As before, only for the purpose of simplified graphical representation, the mass was assumed to be 1 kg per layer for determining the curves in FIGS. 11 and 12. For the cooling power calculations shown in FIGS. 13 and 14, the actual mass of 0.025 kg divided by the number of layers, i.e., five, was used.

The crossing points of the curves of the entropy parameter for the reference cascade as a function of temperature are as specified in Table 4:

TABLE 4
Crossing points for the reference cascade of FIG. 11

| | C1′ | C2′ | C3′ | C4′ |
|---|---|---|---|---|
| m * ΔS [J/K] | 13.4 | 9.89 | 9.82 | 11.71 |
| Deviation | 19.6% | −11.7% | −12.4% | 4.5% |
| from mean | | | | |

The deviations from the mean value given in Table 1 are calculated with respect to a mean value of the crossing points C1′ to C4′, which is 11.21 J/K.

In comparison, the cascade represented by FIG. 12 is based on the same materials in the different layers 1 to 5. However, some of the layers of the cascade of FIG. 12 have different masses than the corresponding layers of the reference cascade of FIG. 11. The relative masses are given in Table 2, wherein a mass of 1 corresponds to 0.0025 kg. The layers are numbered as Layer 1 to Layer 5, which means layer 1′ (cold-side outer layer) to layer 5′ (hot-side outer layer) for the reference cascade of FIG. 11, and layer 1 (cold-side outer layer) to layer 5 (hot-side outer layer) of the embodiment of FIG. 12.

TABLE 5
Relative masses of the layers of the reference cascade and embodiment

| | Layer 1 | Layer 2 | Layer 3 | Layer 4 | Layer 5 | Sum |
|---|---|---|---|---|---|---|
| Reference, | 1 | 1 | 1 | 1 | 1 | 5 |
| FIG. 11 | | | | | | |
| Embodiment, | 0.85 | 0.9 | 1.25 | 1 | 1 | 5 |
| FIG. 12 | | | | | | |

With the mass changes of layers 1, 2, and 3 shown in Table 2, the following crossing point values are achieved for the embodiment of FIG. 12:

TABLE 6
Crossing points for the cascade embodiment of FIG. 12

| | C1 | C2 | C3 | C4 | C5 |
|---|---|---|---|---|---|
| m * ΔS [J/K] | 11.73 | 11.48 | 11.75 | 11.72 | 11.73 |
| Deviation | 0.5% | −1.7% | 0.7% | 0.4% | 0.5% |
| from mean | | | | | |

The deviations from the mean value given in Table 1 are calculated with respect to a mean value of the crossing points C1 to C4, which is 11.67 J/K.

The cooling power was determined for the reference cascade of FIG. 11 and for the embodiment of the cascades of the present invention of FIG. 12. FIG. 13 is a diagram showing the cooling power (CP, in units of Watt) of the cascades of FIG. 11 and FIG. 12 as a function of the temperature span (TS) between the hot-side outer layer and the cold-side outer layer (in units of Kelvin). Different symbols used represent different cascades: the CP values obtained for the embodiment of FIG. 12 are represented by full squares, and the CP values obtained for the reference cascade (FIG. 11) are represented by full diamonds. The cooling power of the embodiment of FIG. 12 is clearly higher than that of the reference cascade of FIG. 11 for all temperature spans up to 6 K. FIG. 14 shows an improvement of the cooling power (ICP) of the embodiment of FIG. 12 in units of percent in relation to the cooling power of the reference cascade described above (FIG. 11) for an operating temperature at the hot-side interface of the cascade of 9.8° C. for different temperature spans TS in units of K, i.e., different operating temperatures at the cold-side interface of the cascade, in the range of temperatures spans TS between 0 and 8 K. The temperature values used for determining the respective temperature spans are to be taken at the hot-side and cold-side entry points into the cascade.

The diagrams of FIG. 13 and FIG. 14 clearly show a significant improvement in cooling power of the magnetocaloric cascade of the embodiment of FIG. 8 in comparison with the reference cascade of FIG. 11 in the range of temperature spans TS between 0 and 6 K.

The improvement is the same for all temperature spans in this range.

The results are similar for cascades where the two outer layers (or even more) at one or both sides are modified using a higher mass per layer or a smaller Curie temperature spacing).

1. A magnetocaloric cascade, comprising:
a sequence of magnetocaloric material layers having different Curie temperatures T_{C}, wherein
the magnetocaloric material layers comprise a cold-side outer layer, a hot-side outer layer and at least three inner layers between the cold-side outer layer and the hot-side outer layer,
for each pair of next neighboring magnetocaloric material layers of the magnetocaloric cascade there exists a respective crossing temperature, at which an entropy parameter mΔS of both respective neighboring magnetocaloric material layers assumes the same crossing-point value, the entropy parameter mΔS being defined as a product of the mass m of the respective magnetocaloric material layer and an amount of its isothermal magnetic entropy change ΔS in a magnetic phase transition of the respective magnetocaloric material layer,
at least two of the inner layers have masses m differing from each other, and
all crossing-point values of the entropy parameter mΔS of all pairs of next neighboring inner layers are equal, either exactly or within a margin of ±15%, to a mean value of all crossing-point values of all pairs of next neighboring inner layers of the magnetocaloric cascade.

2. The magnetocaloric cascade of claim 1, wherein all crossing-point values of the entropy parameter mΔS of all pairs of next neighboring inner layers are equal, either exactly or within a margin of ±10%, to the mean value of all crossing-point values of all pairs of next neighboring inner layers of the magnetocaloric cascade.

3. The magnetocaloric cascade of claim 1, wherein a cold-side outer layer pair formed by the cold-side outer layer and its next neighboring cold-side inner layer or a hot-side outer layer pair formed by the hot-side outer layer and its next neighboring hot-side inner layer or the hot-side and the cold-side outer layer pair exhibit a crossing-point value of the entropy parameter mΔS that is equal, either exactly or within the margin of ±15%, to the mean value of all crossing-point values of all pairs of next neighboring inner layers of the magnetocaloric cascade.

4. The magnetocaloric cascade of claim 1, wherein each pair of next neighboring magnetocaloric layers of the magnetocaloric cascade has a respective Curie-temperature difference amount ΔT_{C} between their respective Curie temperatures, and
wherein the hot-side outer layer or the cold-side outer layer or both the hot-side and cold-side outer layer exhibits a larger ratio mΔSₘₐₓ/ΔT_{C} of the maximum of the entropy parameter mΔS and the Curie-temperature difference amount ΔT_{C} in comparison with any of the inner layers.

5. The magnetocaloric cascade of claim 4, wherein the hot-side outer layer or the cold-side outer layer exhibits an amount of the ratio mΔSₘₐₓ/ΔT_{C} that is at least 1% larger in comparison with any of the inner layers.

6. The magnetocaloric cascade of claim 4, wherein one of the hot-side and cold-side outer layers has a higher amount of the ratio mΔSₘₐₓ/ΔT_{C} than the other, and wherein the other of the hot-side and cold-side outer layers has a higher amount of the ratio mΔSₘₐₓ/ΔT_{C} than any of inner layers.

7. The magnetocaloric cascade of claim 4, wherein the hot-side layer or the cold-side layer exhibits a smaller amount of ΔT_{C} in comparison with any of the inner layers.

8. The magnetocaloric cascade of claim 7, wherein the hot-side layer or the cold-side layer exhibits an amount of ΔT_{C} that is no less than 0.5K.

9. The magnetocaloric cascade of claim 1, wherein the hot-side outer layer or the cold-side outer layer or both the hot-side and cold-side outer layer comprises a sublayer sequence of at least two hot-side sublayers or cold-side sublayers, respectively.

10. A magnetocaloric regenerator, comprising:
the magnetocaloric cascade according claim 1.

11. A heat pump, comprising:
the magnetocaloric regenerator according to claim 10.

12. The heat pump of claim 11, further comprising
a hot-side interface in thermal communication with the hot-side outer layer,
a cold-side interface in thermal communication with the cold-side outer layer, and
a heat transfer system, which is configured to provide a flow of a heat-transfer fluid between the hot-side interface and the cold side interface through the magnetocaloric cascade,
wherein the Curie temperature of the hot-side outer layer is selected to be higher than a temperature of the hot-side interface in operation of the heat pump, or the Curie temperature of the cold-side outer layer is selected to be lower than a temperature of the cold-side interface in operation of the heat pump.

13. A method for fabricating a magnetocaloric cascade, comprising:
fabricating a sequence of different magnetocaloric material layers having different Curie temperatures T_{C}, wherein the magnetocaloric material layers include a cold-side outer layer, a hot-side outer layer and at least three inner layers between the cold-side outer layer and the hot-side outer layer;
fabricating at least two of the inner layers with masses m differing from each other, wherein
for each pair of next neighboring magnetocaloric material layers of the magnetocaloric cascade there exists a respective crossing temperature, at which an pumping power entropy parameter mΔS of both respective neighboring magnetocaloric material layers assumes the same crossing-point value, the entropy parameter mΔS being defined as a product of the mass m of the respective magnetocaloric material layer and an amount of its isothermal magnetic entropy change ΔS in a magnetic phase transition of the respective magnetocaloric material layer;
and wherein
all crossing-point values of the entropy parameter mΔS of all pairs of next neighboring inner layers are equal, either exactly or within a margin of ±15%, to a mean value of all crossing-point values of all pairs of next neighboring inner layers across the magnetocaloric cascade.

14. A heat-pumping method, comprising
performing a heat-pumping sequence using a magnetocaloric regenerator comprising a magnetocaloric cascade according to claim 1.

15. The heat-pumping method of claim 14, wherein
the heat-pumping sequence includes a temperature increase of the magnetocaloric regenerator and—the heat-pumping sequence is performed in thermal communication with a heat sink, which is operated at a temperature that is between 0.5 K and 5 K higher than a Curie temperature of the hot-side outer layer.
